(19) United States
(12) Patent Application Publication
(10) Pub. No.: US 2026/0254760 A1
(43) Pub. Date: Aug. 27, 2026

(54) METHODS, SYSTEMS, AND COMPUTER READABLE MEDIA FOR BOOTSTRAP SERVER FLEET MANAGEMENT WITH INTELLIGENT LOAD DISTRIBUTION

(71) Applicant: Oracle International Corporation, Redwood Shores, CA (US)

(72) Inventors: Gaurav Agnihotri, Bengaluru (IN); Santosh Kumar, Bengaluru (IN); Rahul Sharma, Bengaluru (IN); Abhishek Saxena, Bengaluru (IN); Narayanarao Rednam, Bengaluru (IN)

(21) Appl. No.: 19/651,621

(22) Filed: Apr. 18, 2026

(51) Int. Cl. H04L 47/125

(52) U.S. Cl. CPC H04L 47/125

(57) ABSTRACT

Methods, systems, and computer readable media for bootstrap server fleet management with intelligent load distribution among NFs and data director sites are disclosed. One method includes providing a data director bootstrapping service for managing communications and load distribution between a plurality of NFs and a plurality of data director sites. The method further includes receiving, from each of the data director sites, messages containing load information and capacity information, and maintaining, based on the load information and the capacity information, a data director load balancing database. The method further includes receiving, from one of the NFs, a request message for connecting with one of the data director sites, utilizing the data director load balancing database to intelligently select a data director site to receive a message feed from the NF, and communicating, to the NF, the identity of the selected data director site.

### TECHNICAL FIELD

The subject matter described herein relates to load distribution among 5G network functions (NFs) and data directors. More particularly, the subject matter described herein relates to methods, systems, and computer readable media for bootstrap server fleet management with intelligent load distribution.

### BACKGROUND

In 5G telecommunications networks, a network function that provides service is referred to as a producer NF or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with an NF repository function (NRF). The NRF maintains profiles of available NF instances identifying the services supported by each NF instance. The profile of an NF instance is referred to in Third Generation Partnership Project (3GPP) Technical Specification (TS) 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that can occur in 5G and other types of networks is providing efficient and reliable communication between 5G network functions and data director nodes that distribute copies of network traffic to third party devices. One example of such a data director node is the Oracle Communications Network Analytics Data Director (OCNADD) that receives copies of service-based interface (SBI) messages from 5G NFs via message copy functions of the 5G NFs and distributes the message copies to third party analytics devices. These copies of SBI messages transmitted from 5G NFs to data directors are referred to herein as message feeds.

Problems that exist with the current architecture for distributing messages from 5G NFs to data director sites involve load balancing and failover when a data director site fails. Currently, 5G NFs are statically configured with data director sites to which the 5G NFs each send their respective message feeds. If a data director site becomes overloaded with message feeds from 5G NFs or if there is otherwise a capacity mismatch between the 5G NF message feeds and the data director sites, manual intervention is required to resolve the capacity mismatch or to re-route message feeds when a data director site fails. Requiring manual intervention to address capacity mismatches and/or to reroute message feeds is labor intensive and inefficient.

Accordingly, in light of these and other difficulties, there exists a need for improved methods, systems, and computer readable media for addressing capacity mismatches between 5G NFs and data director sites and for rerouting message feeds when a data director site fails.

### SUMMARY

A method for bootstrap server fleet management with intelligent load distribution among network functions (NFs) and data director sites includes providing a data director bootstrapping service for managing communications and load distribution between a plurality of NFs and a plurality of data director sites. The method further includes receiving, by the data director bootstrapping service and from each of a plurality of data director sites, messages containing load information and capacity information for each of the data director sites. The method further includes maintaining, by the data director bootstrapping service and based on the load information and the capacity information, a data director load balancing database storing load information, capacity information, and status information regarding each of the data director sites. The method further includes receiving, by the data director bootstrapping service and from one of the NFs, a request message for connecting with one of the data director sites. The method further includes utilizing, by the data director bootstrapping service, the data director load balancing database to intelligently select one of the data director sites to receive a message feed from the NF. The method further includes communicating, by the data director bootstrapping service and to the NF, an identity of the selected data director site.

According to another aspect of the subject matter described herein, providing the data director bootstrapping service includes providing a Kafka bootstrapping service for responding to Kafka metadata requests from the NFs.

According to another aspect of the subject matter described herein, receiving the messages containing the load information and the capacity information includes receiving discover Kafka cluster messages from the data director sites.

According to another aspect of the subject matter described herein, receiving the discover Kafka cluster messages includes receiving the discover Kafka cluster messages including Kafka metadata for each of the data director sites.

According to another aspect of the subject matter described herein, receiving the request message for connecting with one of the data director sites includes receiving a Kafka metadata request message from one of the NFs for connecting to one of the data director sites.

According to another aspect of the subject matter described herein, utilizing the data director load balancing database to intelligently select one of the data director sites to receive a message feed from the NF includes utilizing a load balancing algorithm to select one of the data director sites.

According to another aspect of the subject matter described herein, the method for bootstrap server fleet management includes continually communicating, by the data director sites, load and capacity information to the bootstrapping service using a Kafka metadata auto refresh service.

According to another aspect of the subject matter described herein, the method for bootstrap server fleet management includes determining, by the bootstrapping service, that one of the data director sites is overloaded, and communicating, by the bootstrapping service, Kafka metadata to an NF currently sending data to the overloaded data director site with Kafka metadata for an alternate data director site.

According to another aspect of the subject matter described herein, the method for bootstrap server fleet management includes determining, by the bootstrapping service, that one of the data director sites is unavailable, and communicating, by the bootstrapping service, Kafka metadata to an NF currently sending data to the unavailable data director site with Kafka metadata for an alternate data director site.

According to another aspect of the subject matter described herein, the method for bootstrap server fleet management includes publishing, by the NF, a message feed to the selected data director site.

According to another aspect of the subject matter described herein, a system for bootstrap server fleet management with intelligent load distribution among network functions (NFs) and data director sites is provided. The system includes at least one processor. The system further includes a memory. The system further includes a data director bootstrapping service stored in the memory and executable by the at least one processor to: receive, from each of a plurality of data director sites, messages containing load information and capacity information for each of the data director sites; maintain, based on the load information and the capacity information, a data director load balancing database storing load information, capacity information, and status information regarding each of the data director sites; receive, from one of the NFs, a request message for connecting with one of the data director sites; utilize the data director load balancing database to intelligently select one of the data director sites to receive a message feed from the NF; and communicate, to the NF, an identity of the selected data director site.

According to another aspect of the subject matter described herein, the data director bootstrapping service comprises a Kafka bootstrapping service for responding to Kafka metadata requests from the NFs.

According to another aspect of the subject matter described herein, the messages containing the load information and the capacity information comprise discover Kafka cluster messages from the data director sites.

According to another aspect of the subject matter described herein, the data director bootstrapping service is configured to receive the discover Kafka cluster messages including Kafka metadata for each of the data director sites.

According to another aspect of the subject matter described herein, the request message for connecting with one of the data director sites includes a Kafka metadata request message from one of the NFs for connecting to one of the data director sites.

According to another aspect of the subject matter described herein, the data director bootstrapping service is configured to utilize a load balancing algorithm to select one of the data director sites.

According to another aspect of the subject matter described herein, the data director sites continually communicate, to the data director bootstrapping service, load and capacity information using a Kafka metadata auto refresh service.

According to another aspect of the subject matter described herein, the data director bootstrapping service is further configured to: determine that one of the data director sites is overloaded; and communicate Kafka metadata to an NF currently sending data to the overloaded data director site with Kafka metadata for an alternate data director site.

According to another aspect of the subject matter described herein, the data director bootstrapping service is further configured to: determine that one of the data director sites is unavailable; and communicate Kafka metadata to an NF currently sending data to the unavailable data director site with Kafka metadata for an alternate data director site.

According to another aspect of the subject matter described herein, a non-transitory computer readable medium having stored thereon executable instructions that when executed by a processor of a computer control the computer to perform steps is described. The steps include providing a data director bootstrapping service for managing communications and load distribution between a plurality of network functions (NFs) and a plurality of data director sites. The steps further include receiving, by the data director bootstrapping service and from each of a plurality of data director sites, messages containing load information and capacity information for each of the data director sites. The steps further include maintaining, by the data director bootstrapping service and based on the load information and the capacity information, a data director load balancing database storing load information, capacity information, and status information regarding each of the data director sites. The steps further include receiving, by the data director bootstrapping service and from one of the NFs, a request message for connecting with one of the data director sites. The steps further include utilizing, by the data director bootstrapping service, the data director load balancing database to intelligently select one of the data director sites to receive a message feed from the NF. The steps further include communicating, by the data director bootstrapping service and to the NF, an identity of the selected data director site.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a network diagram illustrating current communication between 5G SCP/NF sites and data director sites;

FIG. 3 is a network diagram illustrating an exemplary data director bootstrapping service that monitors load and availability of data director sites and intelligently assigns SCP/NF message feeds to the data director sites;

FIG. 4 is a message flow diagram illustrating exemplary messages exchanged between data director sites, the data director bootstrapping service, and a producer NF site;

FIG. 5 is a block diagram illustrating an exemplary computing platform architecture for implementing the data director bootstrapping service; and

FIG. 6 is a flow chart illustrating an exemplary process for bootstrap server fleet management with intelligent load distribution among network functions and data director sites.

### DETAILED DESCRIPTION

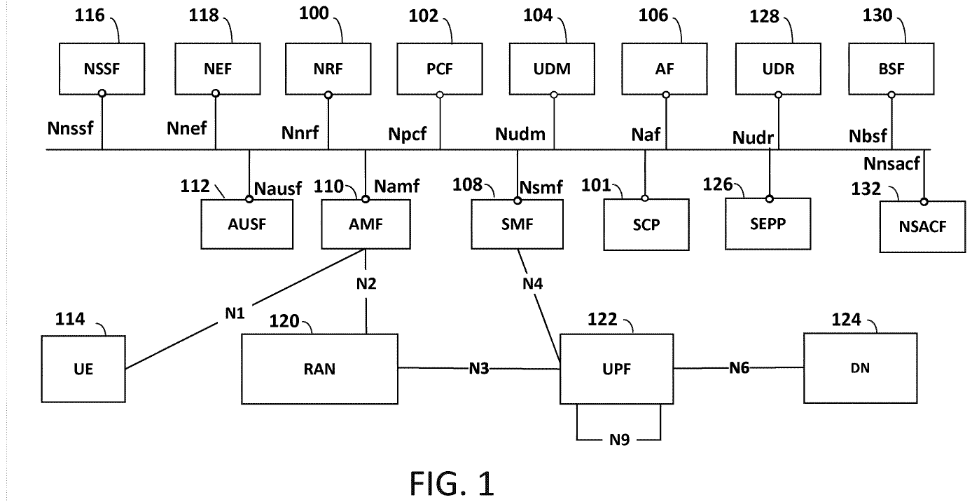

FIG. 1 is a block diagram illustrating an exemplary 5G system network architecture. The architecture in FIG. 1 includes NRF 100 and SCP 101, which may be located in the same public land mobile network (PLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNodeB (gNB) (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A security edge protection proxy (SEPP) 126 filters incoming traffic from another PLMN and performs topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A unified data repository (UDR) 128 stores subscription data for UEs. A binding support function (BSF) 130 manages bindings between packet data unit (PDU) sessions and PCFs. A network slice admission control function (NSACF) 132 performs network slice admission control operations to ensure that network slices are not overburdened by UEs or PDU sessions.

As stated above, problems that may occur in 5G and other types of networks include load balancing and distribution of message feeds from NFs to data director sites. The adoption of 5G is gradually increasing, resulting in higher 5G signaling traffic. The increased 5G traffic throughput means that the data director must also manage higher throughput with supported set of features like aggregation, filtering, message sequencing, message correlating, and extended detailed record (xDR) generation. The NFs and data director traffic processing capacities are not aligned, and capacity mismatches can occur, resulting in additional data director clusters being created.

The data director provides Kafka as an interface to the 5G NFs for the message feed, however, the 5G NFs being clients are not capable of copying message feeds to the different clusters simultaneously and cannot distribute the traffic load to the multiple data director clusters. Moreover, the core functionality of NFs is to manage the 5G signaling, and any additional load distribution functionality directed to a message feed solution increases the complexity and resource burden on the NFs, which is not acceptable to the communication service providers.

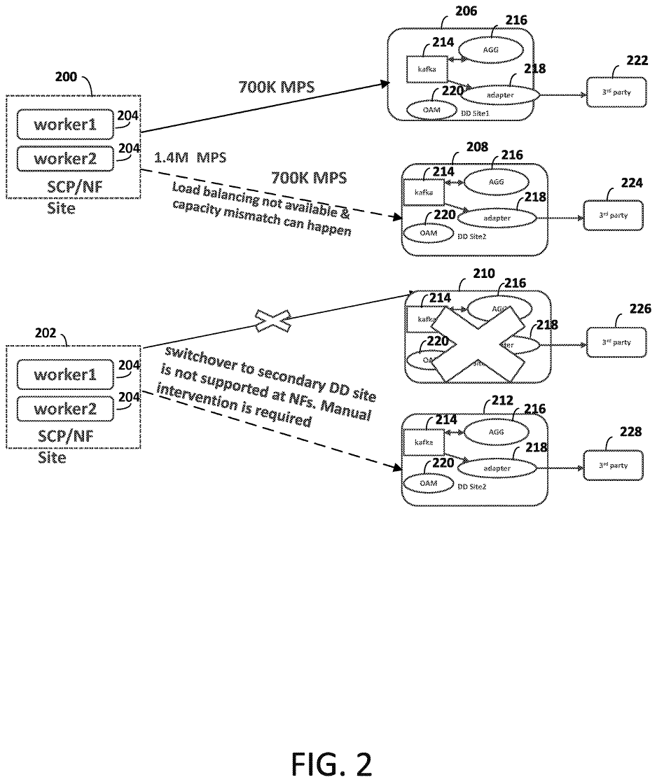

FIG. 2 is a network diagram illustrating current communication between NFs and data director sites. Referring to FIG. 2, 5G NF sites 200 and 202 each include a plurality of worker instances 204 that perform the functions of a 5G NF or an SCP service instance. For example, worker instances 204 may implement service instances of any of the 5G NFs illustrated in FIG. 1. 5G NF sites 200 and 202 each send a message feed to one of a plurality of data director sites 206, 208, 210, and 212. Each data director site includes a Kafka module 214, an aggregation module 216, an adapter 218, and an operations, administration, and maintenance (OAM) module 220. Kafka modules 214 each handle Kafka communications with 5G NF sites 200 and 202. Aggregation modules 216 aggregate message feeds from 5G NF sites 200 and 202. Adapters 218 communicate message feeds to 3^{rd} party sites 222, 224, 226, and 228. OAM modules 220 perform overall management of data director sites 206, 208, 210, and 212. 3^{rd} party sites 222, 224, 226, and 228 may perform network monitoring functions based on the message copy and/or metadata feeds from data director sites 206, 208, 210, and 212.

One problem with the architecture illustrated in FIG. 2 is that 5G SCP/NF sites 200 and 202 lack the intelligence to load balance message feeds among data director sites 206, 208, 210, and 212. As a result, capacity mismatches can occur between 5G SCP/NF sites 200 and 202 and data director sites 206, 208, 210, and 212. In addition, if a data director site goes down or becomes unreachable, 5G SCP/NF sites 200 and 202 lack the intelligence to migrate message feeds to an available data director site. Manual intervention by the network operator is required for both load balancing of message feeds among data director sites and failover when a data director site becomes unreachable.

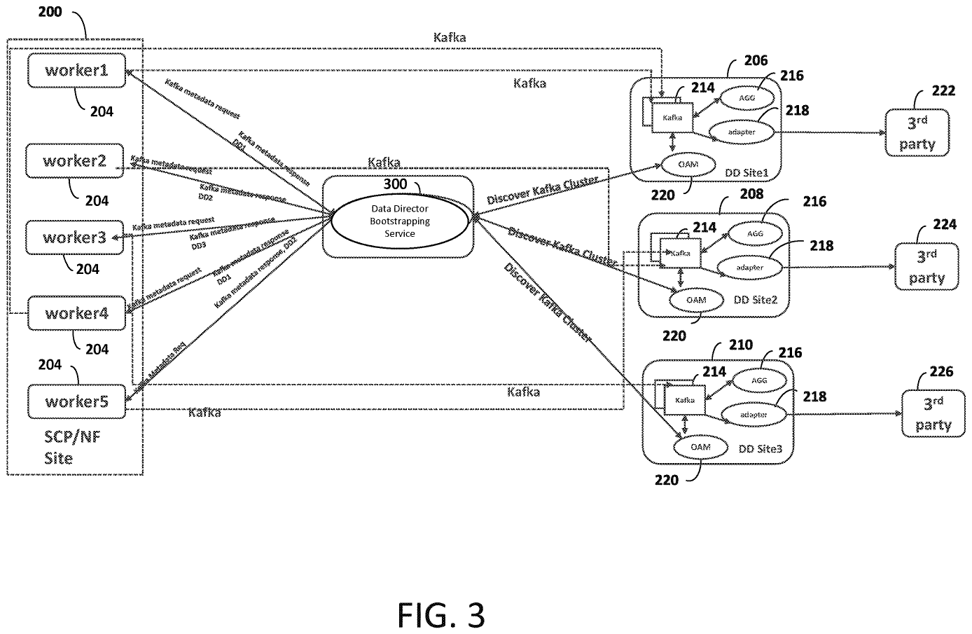

In light of the difficulties with the architecture illustrated in FIG. 2, the subject matter described herein includes a data director bootstrapping service that monitors load and availability of data director sites and intelligently assigns 5G message feeds to data director sites based on the load and availability of the data director sites. FIG. 3 is a network diagram illustrating a data director bootstrapping service that provides these features. Referring to FIG. 3, a data director bootstrapping service 300 monitors capacity, load, and availability of data director sites 206, 208, and 210 and intelligently assigns message feeds from SCP/NF worker instances 204 to the data director sites 206, 208, and 210. In the illustrated example, data director bootstrapping service 300 utilizes Kafka to obtain the load, capacity, and availability information from data director sites 206, 208, and 210 and stores the information in a data director site selection database local to data director bootstrapping service 300. Data director bootstrapping service 300 receives Kafka metadata requests from SCP/NF worker instances 204 at SCP/NF sites, such as SCP/NF site 200, uses the data director load, capacity, and availability information received from data director sites 206, 208, and 210 to select data director sites to receive message copy and/or metadata feeds from each SCP/NF worker instance 204, and communicates the identities of the selected data director sites to SCP/NF worker instances in Kafka metadata response messages.

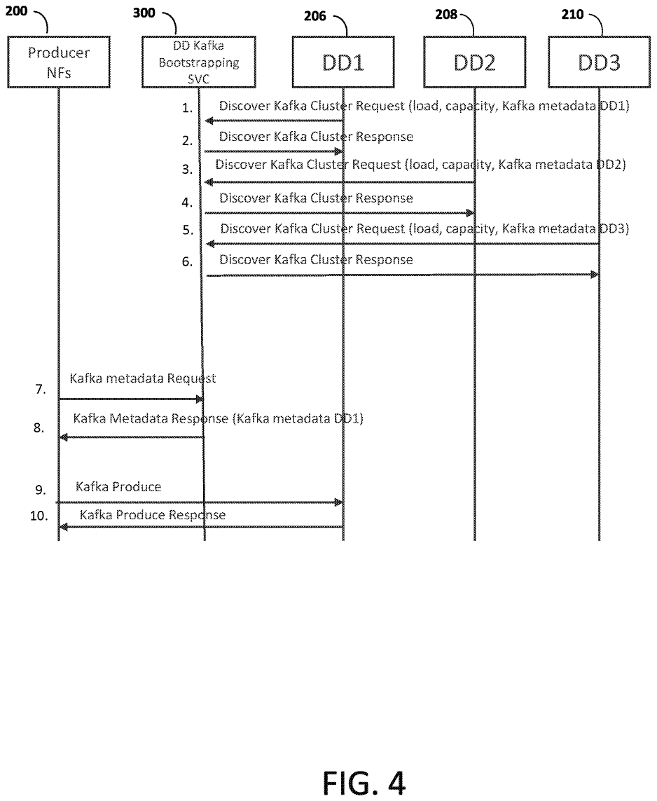

FIG. 4 is a message flow diagram illustrating exemplary messages exchanged between data director sites 206, 208, and 210 and data director bootstrapping service 300 and between data director bootstrapping service and producer NF site 200. Referring to the message flow in FIG. 4, in line 1, data director site 206 generates and sends a discover Kafka cluster message to data director bootstrapping service 300. Data director site 206 includes, in the discover Kafka cluster message, load, capacity, and Kafka metadata for data director site 206. The load information may indicate by percentage, the amount of message processing capacity of data director site 206. The capacity information may indicate the maximum number of messages per second that data director site 206 is capable of handling. For example, the load information may indicate that data director site 206 is 20% loaded and has a capacity of 700,000 messages per second. The Kafka metadata included in the discover Kafka cluster request message may indicate the identity of the Kafka cluster to which data director site 206 belongs. Data director bootstrapping service 300 stores the load and capacity information for data director site 206 in a record in a data director site load balancing database maintained by data director bootstrapping service 300. In line 2, data director bootstrapping service 300 responds with a discover Kafka response message acknowledging receipt of the discover Kafka cluster message.

In line 3, data director site 208 generates and sends a discover Kafka cluster message to data director bootstrapping service 300. Data director site 208 includes, in the discover Kafka cluster message, load, capacity, and Kafka metadata for data director site 208. For example, the load information may indicate that data director site 208 is 30% loaded and has a capacity of 700,000 messages per second. The Kafka metadata included in the discover Kafka cluster message may indicate the identity of the Kafka cluster to which data director site 208 belongs. Data director bootstrapping service 300 stores the load and capacity information for data director site 208 in a record in the data director site load balancing database. In line 4, data director bootstrapping service 300 responds with a discover Kafka response message acknowledging receipt of the discover Kafka cluster message.

In line 5, data director site 210 generates and sends a discover Kafka cluster message to data director bootstrapping service 300. Data director site 210 includes, in the discover Kafka cluster message, load, capacity, and Kafka metadata for data director site 206. For example, the load information may indicate that data director site 210 is 50% loaded and has a capacity of 700,000 messages per second. The Kafka metadata included in the discover Kafka cluster message may indicate the identity of the Kafka cluster to which data director site 210 belongs. Data director bootstrapping service 300 stores the load and capacity information for data director site 210 in a record in the data director site load balancing database. In line 6, data director bootstrapping service 300 responds with a discover Kafka response message acknowledging receipt of the discover Kafka cluster message.

After lines 1-6, the data director site load balancing database maintained by data director bootstrapping service 300 may include the following records:

TABLE 1
Data Director Site Load Balancing Database Records

| Data Director Site Identifier | Load | Capacity | Availability |
|---|---|---|---|
| DD1 | 20% | 700k MPS | UP |
| DD2 | 30% | 700k MPS | UP |
| DD3 | 50% | 700k MPS | UP |

Data director bootstrapping service 300 may utilize the data illustrated in Table 1 to select data director sites to receive message feeds from 5G NFs or SCPs. In one example, data director bootstrapping service 300 may implement a load balancing algorithm that assigns a data director site with the most available capacity to each new Kafka metadata request from a 5G NF or SCP. It should also be noted that data director sites 206, 208, and 210 may each implement a Kafka metadata auto refresh service that operates as a background process that continually sends the discover Kafka cluster messages to data director bootstrapping service 300 to continually update the load, capacity, availability, and Kafka metadata stored in the data director load balancing database.

Data director bootstrapping service 300 may maintain an availability timer for each data director site. If data director bootstrapping service 300 fails to receive a response from a data director site before the timer expires, data director bootstrapping service 300 may mark the corresponding record in the data director site load balancing database to indicate that the data director site is unavailable.

Data director bootstrapping service 300 may continually update the load of each of the data director sites based on the load information published by the data director sites. Data director bootstrapping service 300 may monitor the load on each of the data director sites and, if the load on any of the data director sites exceeds a configurable threshold, data director bootstrapping service 300 may instruct producer NFs currently assigned to the overloaded data director site to begin sending their message feeds to alternate data director sites that are not in an overloaded state.

Returning to the message flow in FIG. 4, in line 7, producer NF site 200 sends a Kafka metadata request message to data director bootstrapping service 300. Data director bootstrapping service 300 receives the request, accesses the data director site load balancing database and determines that data director site 206 is the least loaded data director site. Accordingly, data director bootstrapping service 300 selects data director site 206 to process the message feed from producer NF site 200. In step 8, data director bootstrapping service 300 generates and sends a Kafka metadata response message to producer NF site 200. Data director bootstrapping service 300 includes, in the Kafka metadata response message, the identity of data director site 206. Data director bootstrapping service 300 may also update the data director load balancing database to indicate that a message feed from producer NF site 200 is assigned to data director site 206. Table 2 shown below illustrates the status of the data director site load balancing database after the message feed from producer NF site 200 has been assigned to data director site 206.

TABLE 2
Data Director Site Load Balancing Database
Records with Assigned SCP/NF Sites

| Data Director | | | | Assigned SCP/NF |
|---|---|---|---|---|
| Site Identifier | Load | Capacity | Availability | Sites |
| DD1 | 20% | 700k MPS | UP | Producer NF Site 200 |
| DD2 | 30% | 700k MPS | UP | |
| DD3 | 50% | 700k MPS | UP | |

Data director bootstrapping service 300 may utilize the assigned SCP/NF site information stored in the data director load balancing database to assign a producer NF site to a new data director site when the data director site to which the producer NF site is currently assigned becomes unavailable. For example, in Table 2, if data director site 206 becomes unavailable, data director bootstrapping service 300 may utilize the data director site load balancing database to determine that producer NF site 200 is assigned to data director site 206 and generate and send a new Kafka metadata response message to producer NF site 200 carrying the data director site identifier of data director site 208. In response, producer NF site 200 may connect to data director site 208 and start sending its message feed to data director site 208.

Returning to the message flow in FIG. 4, producer NF site 200 receives the Kafka metadata response in line 8, reads the identifier of data director site 206 from the response, and, in line 9, sends a Kafka produce message including the message feed that producer NF site wishes to publish to data director site 206. In line 10, data director site 206 responds to the Kafka produce message with a Kafka produce response message. Producer NF site 200 may continually send Kafka produce messages including its message feed to data director site 206.

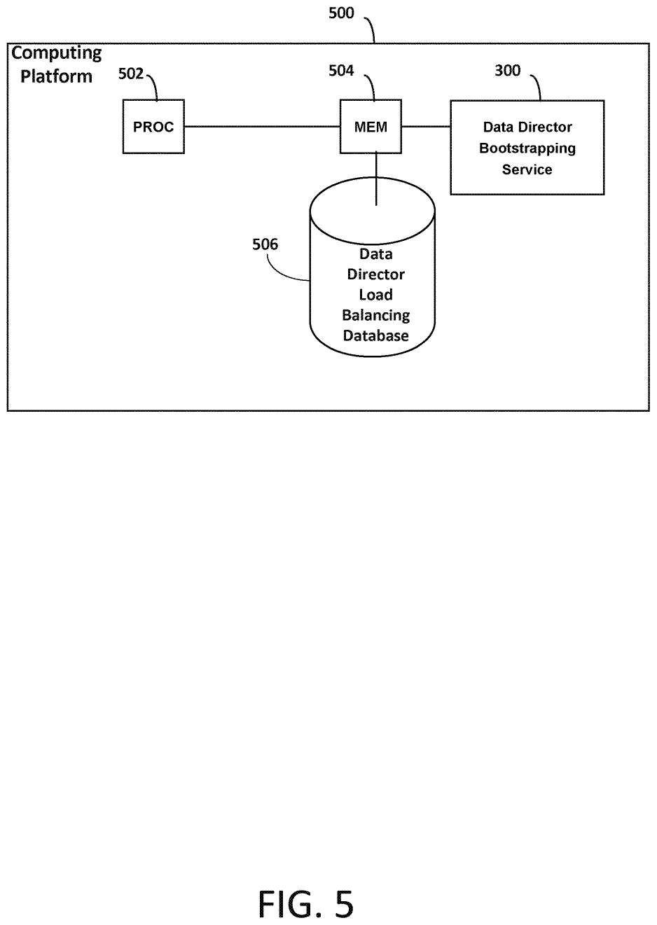

FIG. 5 is a block diagram illustrating an exemplary architecture for a computing platform that implements data director bootstrapping service 300. Referring to FIG. 5, a computing platform 500 includes at least one processor 502 and memory 504. Data director bootstrapping service 300 may be stored in memory 504 and executed by processor 502. Computing platform 500 may also include data director load balancing database 506, which may be stored in memory 504.

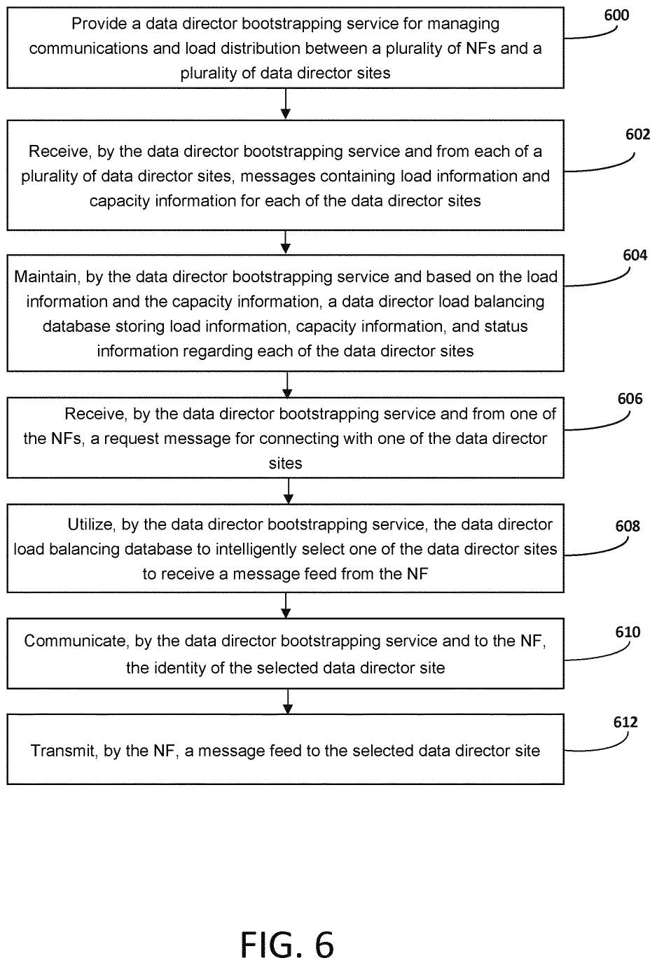

FIG. 6 is a flow chart illustrating an exemplary process for bootstrap server fleet management with intelligent load distribution among network functions (NFs) and data director sites. Referring to FIG. 6, in step 600, the process includes providing a data director bootstrapping service for managing communications and load distribution between a plurality of NFs and a plurality of data director sites. Providing the data director bootstrapping service includes providing a Kafka bootstrapping service that exposes a Kafka bootstrap endpoint to producer NFs and/or SCPs. In such an example, producer NF site 200 sends a Kafka metadata request to the Kafka bootstrap endpoint, and the data director bootstrapping service selects a data director site and returns Kafka metadata (e.g., broker identity information) corresponding to the selected data director site in a Kafka metadata response.

In step 602, the process further includes receiving, by the data director bootstrapping service and from each of a plurality of data director sites, messages containing load information and capacity information for each of the data director sites. In step 604, the process further includes maintaining, by the data director bootstrapping service and based on the load information and the capacity information, a data director load balancing database storing load information, capacity information, and status information regarding each of the data director sites. In an example implementation of steps 602 and 604, each data director site periodically (e.g., every 5 seconds, 30 seconds, or other configurable interval) sends a discover Kafka cluster message that includes current load, capacity, and Kafka metadata. The data director bootstrapping service receives the discover Kafka cluster messages and updates corresponding records in the data director site load balancing database, for example, updating a load field from 20% to 25% when utilization increases and updating an availability field from UP to DOWN when a discover Kafka cluster message is not received from a data director site within a configurable time period. In this manner, the discover Kafka cluster messages serve as heartbeat messages from the data director sites.

In step 606, the process further includes receiving, by the data director bootstrapping service and from one of the NFs, a request message for connecting with one of the data director sites. In step 608, the process further includes utilizing, by the data director bootstrapping service, the data director load balancing database to intelligently select one of the data director sites to receive a message feed from the NF. In an example implementation of step 608, the data director bootstrapping service applies a load balancing algorithm that selects, from among data director sites marked as available, a data director site having a lowest load value and/or a greatest available capacity. In some examples, the data director bootstrapping service computes an availability score using weighted factors such as load percentage, remaining messages-per-second headroom, and recent responsiveness. In the event of a tie, the data director bootstrapping service may select a data director site using a deterministic tie breaker, such as selecting a site having a lowest number of currently assigned SCP/NF sites as reflected in Table 2.

In step 610, the process further includes communicating, by the data director bootstrapping service and to the NF, the identity of the selected data director site. In step 612, the NF sends its message feed to the selected data director site. In an example implementation of steps 610 and 612, after communicating the identity of the selected data director site to producer NF site 200, the data director bootstrapping service updates the data director site load balancing database to associate producer NF site 200 with the selected data director site (e.g., as shown in Table 2). Producer NF site 200 then initiates a Kafka connection to the selected data director site and publishes Kafka produce messages carrying the message feed to the selected data director site.

In an example failover scenario, the data director bootstrapping service maintains an availability timer for each data director site and marks a data director site as unavailable when a discover Kafka cluster message is not received before timer expiration. In response to determining that a currently assigned data director site is unavailable, the data director bootstrapping service identifies the affected producer NF sites using the assigned SCP/NF site information in the data director site load balancing database and transmits updated Kafka metadata identifying an alternate data director site. Similarly, in response to determining that a load value for a data director site exceeds a configurable overload threshold (e.g., 80% or 90%), the data director bootstrapping service may proactively migrate one or more producer NF sites to alternate data director sites by transmitting updated Kafka metadata for the alternate data director sites.

The data director bootstrapping service may facilitate failback operations when a data director site becomes available after being previously available then unavailable. When a data director site becomes available, it communicates its load, capacity, and Kafka metadata to the data director bootstrapping service. The data director bootstrapping service modifies an existing record or adds a new record to the data director load balancing database with the new load, capacity, and availability information and uses the newly added or updated record making subsequent data director site assignment decisions.

Simple configuration changes at the Kafka producer level on the NFs, such as configuring a metadata recovery strategy, are sufficient to support the disclosed functionality. Manual intervention associated with Kafka cluster failures is reduced, which in turn reduces downtime. Because client-side load balancing is not required, the solution reduces the resource footprint on the NFs, allowing the NFs to focus on their core function of managing 5G signaling without incurring the added complexity of load distribution. The approach further enables geographic redundancy of NF message copy feeds with automatic failover and failback. In addition, the data director bootstrapping service can implement any load balancing algorithm without impacting NF behavior, and the NFs and data directors can scale independently and dynamically without affecting one another.

The disclosure of each of the following references is incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.4.0 (2025 September)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for bootstrap server fleet management with intelligent load distribution among network functions (NFs) and data director sites, the method comprising:
providing a data director bootstrapping service for managing communications and load distribution between a plurality of NFs and a plurality of data director sites;
receiving, by the data director bootstrapping service and from each of a plurality of data director sites, messages containing load information and capacity information for each of the data director sites;
maintaining, by the data director bootstrapping service and based on the load information and the capacity information, a data director load balancing database storing load information, capacity information, and status information regarding each of the data director sites;
receiving, by the data director bootstrapping service and from one of the NFs, a request message for connecting with one of the data director sites;
utilizing, by the data director bootstrapping service, the data director load balancing database to intelligently select one of the data director sites to receive a message feed from the NF; and
communicating, by the data director bootstrapping service and to the NF, an identity of the selected data director site.

2. The method of claim 1 wherein providing the data director bootstrapping service includes providing a Kafka bootstrapping service for responding to Kafka metadata requests from the NFs.

3. The method of claim 2 wherein receiving the messages containing the load information and the capacity information includes receiving discover Kafka cluster messages from the data director sites.

4. The method of claim 3 wherein receiving the discover Kafka cluster messages includes receiving the discover Kafka cluster messages including Kafka metadata for each of the data director sites.

5. The method of claim 2 wherein receiving the request message for connecting with one of the data director sites includes receiving a Kafka metadata request message from one of the NFs for connecting to one of the data director sites.

6. The method of claim 1 wherein utilizing the data director load balancing database to intelligently select one of the data director sites to receive a message feed from the NF includes utilizing a load balancing algorithm to select one of the data director sites.

7. The method of claim 2 comprising continually communicating, by the data director sites, load and capacity information to the bootstrapping service using a Kafka metadata auto refresh service.

8. The method of claim 2 comprising determining, by the bootstrapping service, that one of the data director sites is overloaded, and communicating, by the bootstrapping service, Kafka metadata to an NF currently sending data to the overloaded data director site with Kafka metadata for an alternate data director site.

9. The method of claim 2 comprising determining, by the bootstrapping service, that one of the data director sites is unavailable, and communicating, by the bootstrapping service, Kafka metadata to an NF currently sending data to the unavailable data director site with Kafka metadata for an alternate data director site.

10. The method of claim 1 comprising publishing, by the NF, a message feed to the selected data director site.

11. A system for bootstrap server fleet management with intelligent load distribution among network functions (NFs) and data director sites, the system comprising:
at least one processor;
a memory; and
a data director bootstrapping service stored in the memory and executable by the at least one processor to: receive, from each of a plurality of data director sites, messages containing load information and capacity information for each of the data director sites; maintain, based on the load information and the capacity information, a data director load balancing database storing load information, capacity information, and status information regarding each of the data director sites; receive, from one of the NFs, a request message for connecting with one of the data director sites; utilize the data director load balancing database to intelligently select one of the data director sites to receive a message feed from the NF; and communicate, to the NF, an identity of the selected data director site.

12. The system of claim 11 wherein the data director bootstrapping service comprises a Kafka bootstrapping service for responding to Kafka metadata requests from the NFs.

13. The system of claim 12 wherein the messages containing the load information and the capacity information comprise discover Kafka cluster messages from the data director sites.

14. The system of claim 13 wherein the data director bootstrapping service is configured to receive the discover Kafka cluster messages including Kafka metadata for each of the data director sites.

15. The system of claim 12 wherein the request message for connecting with one of the data director sites includes a Kafka metadata request message from one of the NFs for connecting to one of the data director sites.

16. The system of claim 11 wherein the data director bootstrapping service is configured to utilize a load balancing algorithm to select one of the data director sites.

17. The system of claim 12 wherein the data director sites continually communicate, to the data director bootstrapping service, load and capacity information using a Kafka metadata auto refresh service.

18. The system of claim 12 wherein the data director bootstrapping service is further configured to: determine that one of the data director sites is overloaded; and communicate Kafka metadata to an NF currently sending data to the overloaded data director site with Kafka metadata for an alternate data director site.

19. The system of claim 12 wherein the data director bootstrapping service is further configured to: determine that one of the data director sites is unavailable; and communicate Kafka metadata to an NF currently sending data to the unavailable data director site with Kafka metadata for an alternate data director site.

20. A non-transitory computer readable medium having stored thereon executable instructions that when executed by a processor of a computer control the computer to perform steps comprising:
providing a data director bootstrapping service for managing communications and load distribution between a plurality of network functions (NFs) and a plurality of data director sites;
receiving, by the data director bootstrapping service and from each of a plurality of data director sites, messages containing load information and capacity information for each of the data director sites;
maintaining, by the data director bootstrapping service and based on the load information and the capacity information, a data director load balancing database storing load information, capacity information, and status information regarding each of the data director sites;
receiving, by the data director bootstrapping service and from one of the NFs, a request message for connecting with one of the data director sites;
utilizing, by the data director bootstrapping service, the data director load balancing database to intelligently select one of the data director sites to receive a message feed from the NF; and
communicating, by the data director bootstrapping service and to the NF, an identity of the selected data director site.
